(19) United States
(12) Patent Application Publication
(10) Pub. No.: US 2011/0109930 A1
(43) Pub. Date: May 12, 2011

(54) PRINTING CONTROL APPARATUS AND METHOD

(75) Inventors: Yong-in EOM, Hwaseong-si (KR); Young-soo HAN, Yongin-si (KR)

(73) Assignee: Samsung Electronics Co., Ltd., Suwon-si (KR)

(21) Appl. No.: 12/763,288

(22) Filed: Apr. 20, 2010

(30) Foreign Application Priority Data
Nov. 9, 2009 (KR) 2009-0107706

(51) Int. Cl. G06F 3/12

(52) U.S. Cl. 358/1.13

(57) ABSTRACT

A printing control apparatus is provided. A printing control apparatus includes a storage unit to store a plurality of documents, a user interface (UI) unit to select a plurality of documents from among the plurality of documents stored in the storage unit, an XPS file conversion unit to convert each selected document into an XPS file, an XPS file processing unit to combine the converted XPS files into a single XPS file, and a communication interface unit to transmit the combined XPS file to the image forming apparatus. Therefore, a user can combine documents made by diverse application programs into a single document, and divide specific pages in a document as a separate document.

### CROSS-REFERENCE TO RELATED APPLICATIONS

This application claims priority under 35 U.S.C. §119 (a) from Korean Patent Application No. 10-2009-0107706, filed on Nov. 9, 2009, in the Korean Intellectual Property Office, the disclosure of which is incorporated herein by reference in its entirety.

### BACKGROUND

1. Field of the Invention

The present general inventive concept relates to a printing control apparatus and method. More particularly, the present general inventive concept relates to a printing control apparatus and method of combining documents made by one or more application programs into a single document or dividing specific pages in a document as a separate document.

2. Description of the Related Art

Image forming apparatuses are devices that print printing data generated by a terminal device, such as computer, on a recording medium. Example of image forming apparatuses include copiers, printers, facsimile machines, and multifunction peripherals (MFP) implementing the functions of the aforementioned machines using a single device.

Recent image forming apparatuses can support printing of XML paper specification (XPS) files using an XPS emulator as well as printing data written in conventional Page Description Languages (PDL) such as PostScript (PS) and Printer Command Language.

An XPS file is a fixed-layout electronic file designed to preserve document fidelity and be capable of sharing the file, which is a zip archive in which all the resources needed for a corresponding document or job are systemized in a directory structure and the relationship between the directories is made up using an Extensible Markup Language (XML). Such an XPS file has a logical structure of a tree type as illustrated in FIG. 19.

More specifically, an XPS file consists of levels such as a job level, a document level, and a page level. Each document level and each page level may include a plurality of documents and a plurality of pages, respectively. Different printing information can be set for each document and each page.

However, in a conventional art, combining documents made by diverse application programs into a single document using the characteristics of the XPS file or dividing a single document into multiple XPS files is not available.

### SUMMARY

The present general inventive concept provides a printing control apparatus and method of combining documents made by one or more application programs into a single document or dividing specific pages in a document as a separate document.

Additional features and utilities of the present general inventive concept will be set forth in part in the description which follows and, in part, will be obvious from the description, or may be learned by practice of the general inventive concept.

Exemplary embodiments of the present general inventive concept may be achieved by providing a printing control apparatus which is connected to an image forming apparatus, the printing control apparatus including a storage unit to store a plurality of documents, a user interface (UI) unit to receive a selection of a plurality of documents from among the plurality of documents stored in the storage unit, an XPS file conversion unit to convert each selected document into an XML paper specification (XPS) file, an XPS file processing unit to combine the converted XPS files into a single XPS file, and a communication interface unit to transmit the combined XPS file to the image forming apparatus.

The storage unit may store the combined XPS file.

The UI unit may receive a command to print a single document and receives a selection of another document to be combined with the single document.

The UI unit may receive settings of a printing option for each selected document, and the XPS file conversion unit converts each selected documents into an XPS file according to the received settings of the printing option for each of the selected documents on a corresponding print ticket.

The XPS file conversion unit may render the selected document by applying the set printing option to the selected document, and convert the rendered document into an XPS file.

The XPS file conversion unit may determine whether the selected document is an XPS file, and when the selected document is not an XPS file, the XPS file conversion unit may convert the selected document into an XPS file.

The XPS file processing unit may combine the converted XPS files into the single XPS file so that the converted XPS files can be located in different Fixed Documents of the combined XPS file.

The XPS file processing unit may combine the converted XPS files into the single XPS file so that the converted XPS files can be located in the same FixedDocument of the combined XPS file.

The XPS file processing unit may remove an overlapping resource by analyzing a relationship file in the combined XPS file.

The overlapping resource may be at least one of a font resource and an image resource.

The XPS file processing unit may reconstruct a print ticket in the combined XPS file by analyzing a printing option set for the combined XPS file.

Exemplary embodiments of the present general inventive concept may be achieved by providing a printing control method of a printing control apparatus which is connected to an image forming apparatus, the method including selecting a plurality of documents, converting each selected document into an XML paper specification (XPS) file, combining the converted XPS files into a single XPS file, and transmitting the combined XPS file to the image forming apparatus.

The method may further include storing the combined XPS file.

In the selecting the plurality of documents, the method may include receiving a selection of another document to be combined with the single document when a command to print a document may be received.

The method may further include receiving settings of a printing option for each selected document, where the converting each selected document into the XPS file includes converting each selected document for a print ticket according to the set printing option.

In the converting each selected document into the XPS file, the selected document may be rendered by applying the set printing option to the selected document, and the rendered document may be converted into the XPS file.

In the combining the converted XPS files into the single XPS file, it may be determined whether the selected document is an XPS file, and if the selected document is not an XPS file, the selected document may be converted into the XPS file.

In the combining the converted XPS files into the single XPS file, the converted XPS files may be converted into the single XPS file so that the converted XPS files can be located in different FixedDocuments of the combined XPS file.

In the combining the converted XPS files into the single XPS file, the converted XPS files may be converted into the single XPS file so that the converted XPS files can be located in the same FixedDocument of the combined XPS file.

In the combining the converted XPS files into the single XPS file, an overlapping resource may be removed by analyzing a relationship file in the combined XPS file.

The overlapping resource may be at least one of a font resource and an image resource.

In the combining the converted XPS files into the single XPS file, a print ticket in the combined XPS file may be reconstructed by analyzing a printing option set for the combined XPS file.

Exemplary embodiments of the present general inventive concept may be achieved by providing a printing control apparatus which is connected to an image forming apparatus, the printing control apparatus including a user interface (UI) unit to receive a selection of a document to be printed and to receive a selection of an area to be divided from the selected document, an XPS file conversion unit to convert the selected document into an XML paper specification (XPS) file, an XPS file processing unit to divide the converted XPS file into a plurality of XPS files according to the set area to be divided, and a communication interface unit to transmit the divided XPS files to the image forming apparatus.

The printing control apparatus may further include a storage unit to store the divided XPS files.

The UI unit may select the area to be divided after the selected document is converted into the XPS file, and select the area to be divided according to a FixedDocument of the converted XPS file.

The UI unit may select a printing option for each area to be divided, and the XPS file conversion unit may reflect the set printing option on a print ticket corresponding to each area to be divided when converting the selected document into the XPS file.

The XPS file processing unit may divide the converted XPS file into the plurality of XPS files by dividing a resource and a printing option which are shared by the areas to be divided.

Exemplary embodiments of the present general inventive concept may be achieved by providing a printing control method of a printing control apparatus which is connected to an image forming apparatus, the method including selecting a document to be printed, selecting an area to be divided from the selected document, converting the selected document into an XML paper specification (XPS) file, dividing the converted XPS file into a plurality of XPS files according to the set area to be divided, and transmitting the divided XPS files to the image forming apparatus.

The method may further include storing the divided XPS files.

In the selecting the area to be divided from the selected document, the area to be divided may be selected according to a Fixed Document of the converted XPS file after the selected document is converted into the XPS file.

The method may further include selecting a printing option for each area to be divided, where the converting the selected document into the XPS file includes converting selected document into the XPS file according to the set printing option on a print ticket corresponding to each area to be divided.

In the dividing the converted XPS file into the plurality of XPS files according to the set area to be divided, the converted XPS file may be divided into the plurality of XPS files by dividing a resource and a printing option which are shared by the areas to be divided.

Exemplary embodiments of the present general inventive concept may also provide a method of controlling a printing control apparatus which is connected to an image forming apparatus, the method including receiving a selection of one or more documents with at least one of a user interface apparatus and a communication apparatus of the printing control apparatus, converting each selected document into a paper specification file with a driver apparatus of the printing control apparatus, combining each of the converted paper specification files into a single paper specification file with the printing control apparatus, and transmitting the combined paper specification file with a communication apparatus of the printing control apparatus to the image forming apparatus.

The method may also include where the converting each selected file includes converting the selected document when the selected document is determined not to be a paper specification file, and determining whether all of the selected documents have been converted into the paper specification files.

Exemplary embodiments of the present general inventive concept may also provide a method of controlling a printing control apparatus which is connected to an image forming apparatus, the method including receiving a selection of one or more documents with at least one of a user interface apparatus and a communication apparatus of the printing control apparatus, receiving a selection with at least one of a user interface apparatus and a communication apparatus of the printing control apparatus of an area to be divided in at least one of the selected documents, converting the selected document into a paper specification and dividing the selected area of the converted document into a plurality of paper specification files according to the selected division areas with a driver apparatus of the printing control apparatus, and transmitting the plurality of paper specification files with a communication apparatus of the printing control apparatus to the image forming apparatus.

### BRIEF DESCRIPTION OF THE DRAWINGS

These and/or other features and utilities of the present general inventive will become apparent and more readily appreciated from the following description of the embodiments, taken in conjunction with the accompanying drawings of which:

FIG. 1A is a block diagram illustrating a printing control apparatus according to exemplary embodiments of the present general inventive concept;

FIG. 1B is a block diagram illustrating an image forming apparatus including the printing control apparatus of FIG. 1A and an image forming unit according to exemplary embodiments of the present general inventive concept;

FIGS. 2 to 12 illustrate user interface windows according to exemplary embodiments of the present general inventive concept;

FIGS. 13A and 13B illustrate structures of an XPS file according to exemplary embodiments of the present general inventive concept;

FIGS. 14A, 14B, 15A and 15B illustrate structures of an XPS file to which printing options are applied according to exemplary embodiments of the present general inventive concept;

FIG. 16 is a flow chart illustrating a printing control method according to exemplary embodiments of the present general inventive concept;

FIG. 17 is a flow chart illustrating a method of removing an overlapping resource according to exemplary embodiments of the present general inventive concept;

FIG. 18 is a flow chart illustrating a printing control method according to exemplary embodiments of the present general inventive concept; and

FIG. 19 illustrates a logical structure of an XPS file according to exemplary embodiments of the present general inventive concept.

### DETAILED DESCRIPTION OF THE EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures.

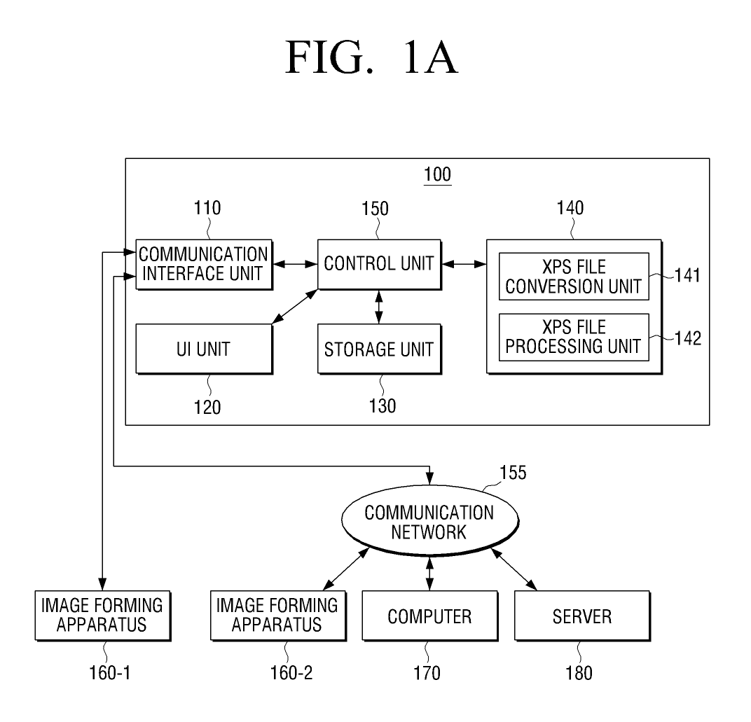

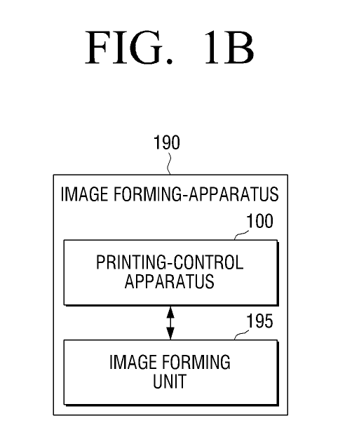

FIG. 1A is a block diagram illustrating a printing control apparatus 100 according to exemplary embodiments of the present general inventive concept.

Referring to FIG. 1A, the printing control apparatus 100 may include a communication interface unit 110, a user interface (UI) unit 120, a storage unit 130, a driver unit 140, and a control unit 150. The printing control apparatus 100 can be communicatively coupled to an image forming apparatus 160-1, and/or can be coupled to the image forming apparatus 160-2 via a wired and/or wireless communication network 155. A computer 170 and/or a server 180 may be communicatively coupled to the communication network 155.

Specifically, the printing control apparatus 100 may combine a plurality of documents into a single XPS file, and/or divide a single document into a plurality of XML paper specification (XPS) files. Hereinafter, combining a plurality of documents into a single XPS file, and dividing a single document into a plurality of XPS files are described separately.

The communication interface unit 110 can transmit a generated XPS file to an image forming apparatus 160. That is, the communication interface unit 110 of the printing control apparatus may be communicatively coupled to the image forming apparatus 160, or may be communicatively coupled to the image forming apparatus 160 via a wired and/or wireless communication network 155. More specifically, the communication interface unit 110 can be connected to an image forming apparatus and can transmit an XPS file combined by the driver unit 140 to the image forming apparatus 160. The communication interface unit 110 may be implemented as a parallel interface, a Universal Serial Bus (USB) interface, or a wireless interface so as to connect the printing control apparatus 100 to an external device (e.g., to connect it to the communication network 155 and/or the image forming apparatus 160).

An XPS file can include printing data in which printing options are set in a tree structure and/or any other suitable structure to carry out the exemplary embodiments of the present general inventive concept as disclosed herein having a plurality of layers. More specifically, an XPS file has a plurality of layers, and different printing options can be set for each node of each layer and each tree.

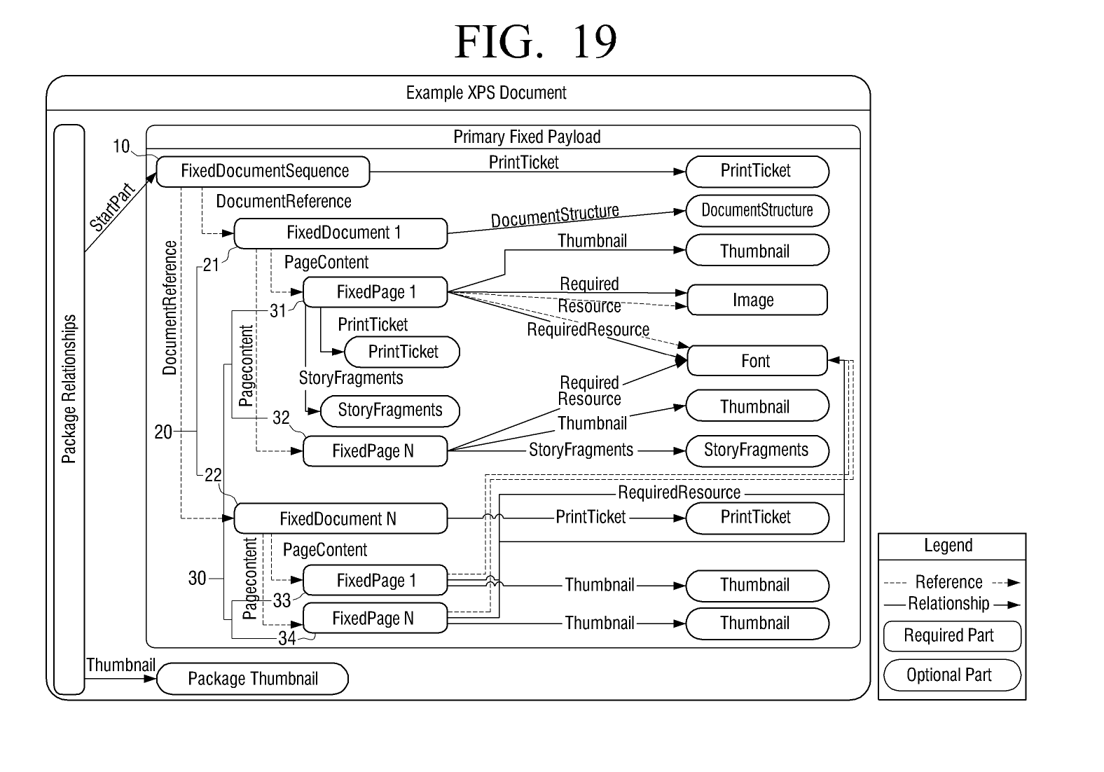

For example, as illustrated in FIG. 19, an XPS file may have three layers such as a job level 10, a document level 20, and a page level 30, and different printing options may be set for a plurality of documents and a plurality of pages in each document level 20 and each page level 30. One or more printing options can be set (e.g., selections for one or more printing options may be received by the UI unit 120 and/or the communication interface unit 110, or may be stored in the storage unit 130) so that “double-sided printing” is set for the job level 10 as a printing option, “2n-up” is set for a first document 21 on the document level 20 as a printing option, “A4” is set for a first page 31 of the first document 21 as a printing option, and “A5” is set for a second page 32 of the first document 21 as a printing option. A printing option at one or more nodes (e.g., at each node) of the logical structure can be applied to lower layers. Printing options may also be set for a last document 22 on the document level 20, and options may be set in the page level 30 for the first page 33 and a next page 34 of the last document 22. In exemplary embodiments of the present general inventive concept, there may be zero, one, or a plurality of documents in the document level 20 between the first document 21 and the last document 22.

Referring to FIG. 1A, the UI unit 120 can include a plurality of function keys so that the user can set or select one or more functions supported by the printing control apparatus 100, and can display information provided by the printing control apparatus 100. That is, the UI unit 120 may receive one or more selections of functions that may be supported by the printing control apparatus 100. The UI unit 120 may be implemented as a device to perform input and output operations, such as a touch pad, or as combination of a mouse and a monitor, or any other suitable input and/or output device to carry out the exemplary embodiments of the present general inventive concept.

The UI unit 120 can receive a plurality of selections of documents, and can display documents stored (e.g., stored in the storage unit 130, the image forming apparatus 160, the computer 170, the server 180, and/or the image forming apparatus 190 illustrated in FIG. 1B and described below) so that a user can select a plurality of documents. The UI unit 120 can receive a selection of a plurality of documents by receiving a command to print at least a single document, and receiving one or more selections of documents to be combined.

The UI unit 120 may receive a setting of a printing option. More specifically, through the UI unit 120, the user can set a printing option individually for each document, can set a printing option for one or more selected documents, and/or set a printing option for the entire set of documents.

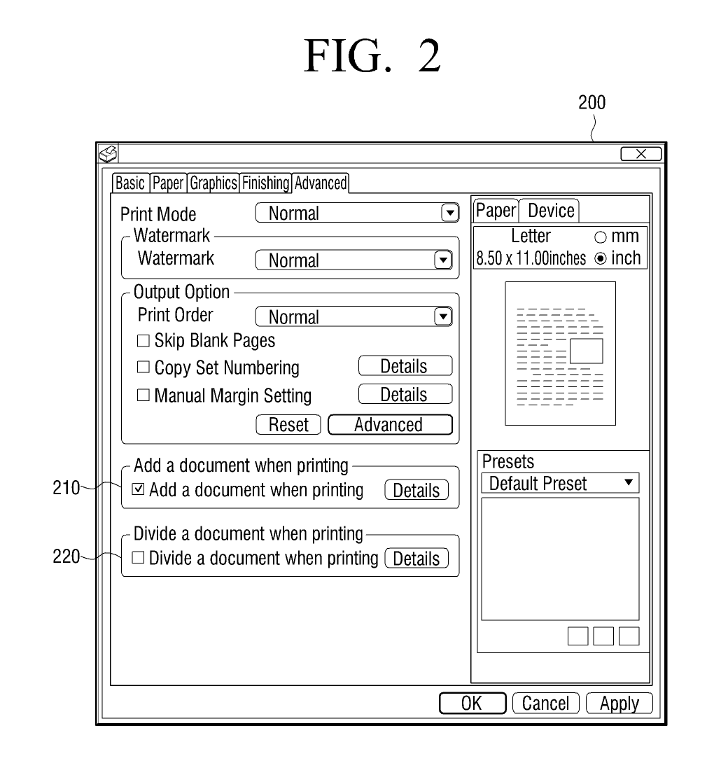

Examples of UI windows displayed by the UI unit 120 are described with reference to FIGS. 2 to 8.

The storage unit 130 can store a plurality of documents. More specifically, the storage unit 130 can store documents generated using one or more applications by the user. The documents indicate files which can be printed by the image forming apparatus, including image documents (e.g., files having extensions such as JPG and PNG), word processing documents (e.g., files having extensions such as HWP, DOC, and GUL), presentation documents (e.g., files having extensions such as PPT), and electronic documents for distribution (e.g., files having extensions such as PDF and XPS).

The storage unit 130 can store an XPS file generated by the driver unit 140. The storage unit 130 may be a storage medium mounted in the printing control apparatus 100, a removable disk including USB memory, or a computer 170 and/or a web server (e.g., server 180) which is connected to a network (e.g., communication network 155).

The driver unit 140 can combine a plurality documents selected by the user into a single XPS file. The driver unit 140 can include an XPS file conversion unit 141 and an XPS file processing unit 142.

The XPS file conversion unit 141 can determine whether or not each selected document is an XPS file. If a document selected by the user is an XPS file, the document may not need to be converted into an XPS file. Accordingly, whether or not a selected document is an XPS file may be determined before the selected document is converted into an XPS file. Whether or not a selected document is an XPS file can be determined by checking an initial binary of the selected document. More specifically, since an XPS file is a file in which data and resources made in XML can be compressed, for example, in a zip format, the initial binary has a value of “50 4B 03 04”. Accordingly, the XPS file conversion unit 141 can determine whether or not the selected document is an XPS file by checking whether or not the initial binary of the selected document has “50 4B 03 04”.

The XPS file conversion unit 141 can convert each selected document into an XPS file. More specifically, if the selected document is not an XPS file, the XPS file conversion unit 141 can convert the selected document into an XPS file (or generates an XPS file). Throughout this specification, “converting a selected document into an XPS file” can have the same meaning as “generating an XPS file.”

When converting the selected document into an XPS file, the XPS file conversion unit 141 can perform the conversion according to at least the set printing options on corresponding print tickets. More specifically, if printing options are set for each document and/or set for one or more selected documents through the UI 120, the XPS file conversion unit 141 converts each document according to the printing options on corresponding print tickets of an XPS file, and converts the document into an XPS file. For example, if the user sets printing option “A4” for the entire document A, the XPS file conversion unit 141 can set “A4” for a print ticket of a job level of document A converted into an XPS file. If the user sets printing option “A4” for specific pages of document A, the XPS file conversion unit 141 can set “A4” for print tickets of a page level corresponding to the specific pages of document A converted into an XPS file.

When converting the selected document into an XPS file, the XPS file conversion unit 141 can apply a set printing option to the XPS file. For example, if the user selects printing of one or more specific pages in the selected document (for example, if the user selects printing of odd-numbered pages), the XPS file conversion unit 141 can generate an XPS file including resources corresponding to the selected pages.

If a printing option set by the user is to be rendered, the XPS file conversion unit 141 can render a document by applying the set printing option to the document, and can convert the rendered document into an XPS file. For example, if the user sets a watermark or “N-up” for a document as a printing option, the XPS file conversion unit 141 can render the document by applying the watermark or “N-up” to the document and converts the rendered document into an XPS file.

The XPS file processing unit 142 can combine the converted XPS files into a single XPS file. More specifically, the XPS file processing unit 142 may combine the converted XPS files to be located in different FixedDocuments of the combined XPS file, and/or combine the converted XPS files to be located in the same FixedDocument of the combined XPS file.

The XPS file processing unit 142 can analyze a relationship file in the combined XPS file and can remove an overlapping resource. More specifically, documents made by different application programs may have, for example, a common font and a common image such as a company logo and confidentiality warning. Accordingly, the XPS file processing unit 142 can analyze a relationship file in the combined XPS file and can remove an overlapping font resource and/or an overlapping image resource.

The XPS file processing unit 142 can analyze a printing option set for the combined XPS file and can reconstruct print tickets of the combined XPS file. More specifically, since a printing option for an XPS file may be set in print tickets, the XPS file processing unit 142 can hierarchically analyze the print tickets of the combined XPS file and can reconstruct the print tickets so that a printing option commonly set for a lower level can be set in a print ticket of an upper level. For example, if printing option “A4” is set for all of the print tickets of the page level, the XPS file processing unit 142 can set printing option “A4” in a print ticket of the document level and can delete printing option “A4” from the print tickets of the page level so that the print ticket can be reconstructed. When the printing option “A3” is set in the print tickets of the document level, the XPS file processing unit 142 can set printing option “A3” in a print ticket of the job level and can delete printing option “A3” from the print tickets of the document level so that the print ticket can be reconstructed.

The control unit 150 can control the components of the printing control apparatus 100, and may also control printing operations of the image forming apparatus 160 illustrated in FIG. 1A and/or the image forming unit 195 of the image forming apparatus 190 illustrated in FIG. 1B and described below. That is, when the control unit 150 receives a command to print a document or a command to combine documents through the UI unit 120 and/or via the communication interface unit 110 (e.g., commands from the computer 170, the server 180 etc.), the control unit 150 can control the UI unit 120 to display a UI window to select a plurality of documents and a printing option for each document, and can control the driver unit 140 to combine a plurality of documents into a single XPS file.

The control unit 150 can control the communication interface unit 110 to transmit the combined XPS file to an image forming apparatus (e.g., the image forming apparatus 160 illustrated in FIG. 1A and/or the image forming unit 195 of the image forming apparatus 190 as illustrated in FIG. 1B as described below). More specifically, in response to a user command to print the document, the control unit 150 can control the communication interface unit 110 to transmit the XPS file combined by the driver unit 140 to the image forming apparatus 160 and/the image forming unit 195 of the image forming apparatus 190.

The control unit 150 can control the storage unit 130 to store the XPS file combined by the driver unit 140. More specifically, since an XPS file can have a document file format as well as a spool file format, the XPS file can be used repeatedly. Accordingly, the control unit 150 can store the combined XPS file in the storage unit 130. Alternatively, the control unit 150 may store the combined XPS file in computer 170 and/or server 180. The control unit 150 may store the combined XPS file in the storage unit 130 with a name selected by the user or with a preset name. This operation may be performed according to the user's selection, or may be performed automatically without the user's command to store the combined XPS file.

As described above, the printing control apparatus 100 according to exemplary embodiments of the present general inventive concept can combine documents made by one or more application programs into a single XPS file, such that a user the use can easily manage a plurality of documents. The printing control apparatus 100 can remove overlapping resources when generating an XPS file, so the size of the XPS file can be reduced and thus performance of the image forming apparatus to process the XPS file can be increased.

The communication interface unit 110 can transmit a generated XPS file to an image forming apparatus (e.g., the image forming apparatus 160 that is directly coupled to the communication interface unit 110, and/or the image forming apparatus 160 that is coupled to the communication interface unit 110 via the communication network 155, and/or the image forming unit 195 of the image forming apparatus 190 illustrated in FIG. 1B and described below). More specifically, the communication interface unit 110 can be connected to an image forming apparatus (e.g., the image forming apparatus 160 and/or the image forming unit 195 of the image forming apparatus 190) and can transmit a plurality of XPS files divided by the driver unit 140 to the image forming apparatus. The communication interface unit 110 may be implemented as a parallel interface, a USB interface, or a wireless interface so as to connect the printing control apparatus 100 to an external device.

Alternatively, as illustrated in FIG. 1B, the printing control apparatus 100 as disclosed throughout may be included in an image forming apparatus 190. The printing control apparatus may be communicatively coupled to the image forming unit 195 to transmit control information and printing data so that the image forming unit can print the printing information. The image forming unit 195 can be a laser printing unit, an ink-jet printing unit, and/or any other suitable image forming unit to carry out the exemplary embodiments of the present general inventive concept as disclosed herein.

Referring to FIG. 1A, UI unit 120 can include a plurality of function keys so that the user can set and/or select diverse functions supported by the printing control apparatus 100, and can display information provided by the printing control apparatus 100. The UI unit 120 may perform input and output operations, and may be a touch pad, or as combination of a mouse and a monitor, and/or any other suitable device in order to carry out the exemplary embodiments of the present general inventive concept as disclosed herein. The user can select a document to be printed and/or a document to be divided through a UI window provided by the UI unit 120.

The UI unit 120 can receive settings of an area to be divided in the selected document. More specifically, the user can set an area to be divided in the selected document according to page or according to FixedDocument through the UI unit 120. For example, if a document selected by the user is an XPS file generated according to the first exemplary embodiment of the present general inventive concept, the UI unit 120 may display the documents contained in the XPS file and receive settings of an area to be divided according to a document.

The UI unit 120 can receive settings of a printing option for a document. More specifically, the UI unit 120 can receive settings of a printing option for one or more areas (e.g., each area and/or one or more selected areas) to be divided or settings of a printing option for the entire document.

Examples of UI windows displayed by the UI unit 120 are described with reference to FIGS. 2 and 9 to 12.

The storage unit 130 can store a document. More specifically, the storage unit 130 can store documents generated by one or more applications used by the user. The documents indicate files which can be printed by the image forming apparatus, including image documents such as JPG and PNG, word documents such as HWP, DOC, and GUL, presentation documents such as PPT, and electronic documents for distribution such as PDF and XPS.

The storage unit 130 can store a plurality of XPS files divided by the driver unit 140. The storage unit 130 may be implemented with a storage medium mounted in the printing control apparatus 100, a removable disk including USB memory, or a web server (e.g., server 180) and/or computer (e.g., computer 170) which is connected to a network (e.g., communication network 155).

The driver unit 140 can divide a document selected by the user into a plurality of XPS files according to a set area to be divided. The driver unit 140 may include an XPS file conversion unit 141 and an XPS file processing unit 142.

The XPS file conversion unit 141 can determine whether or not a selected document is an XPS file. If a document selected by the user is an XPS file, the document may not need to be converted into an XPS file. Accordingly, whether or not a selected document is an XPS file can be determined before the selected document is converted into an XPS file. In exemplary embodiments of the present general inventive concept, whether or not the selected document is an XPS file can be determined by checking an initial binary of the selected document.

The XPS file conversion unit 141 can convert the selected document into an XPS file. More specifically, when converting the selected document into an XPS file, the XPS file conversion unit 141 can apply a printing option set by the user to a print ticket corresponding to a set area. For example, in document A that can include a total of 10 pages, if the user sets area “a” (pages 1-3) and area “b” (pages 6-7) as areas to be divided, sets printing option “A4” for area “a”, and sets printing option “A3” for area “b”, the XPS file conversion unit 141 can convert document A into an XPS file, can set printing option “A4” in each print ticket corresponding to pages 1-3, and can set printing option “A3” in each print ticket corresponding to pages 6-7.

When converting the selected document into an XPS file, the XPS file conversion unit 141 can apply a set printing option to the XPS file. For example, if the user sets a watermark or “N-up” for a document as a printing option, the XPS file conversion unit 141 can render the document by applying the watermark or “N-up” to the document and can convert the rendered document into an XPS file.

The XPS file processing unit 142 can divide the generated XPS file into a plurality of XPS files at least according to the set areas to be divided. More specifically, the XPS file processing unit 142 can divide the generated XPS file into a plurality of XPS files by dividing a resource and a printing option which are shared by the areas to be divided. For example, in document A including pages 1-7, if the user sets pages 1-3 and pages 6-7 to be areas to be divided, the XPS file processing unit 142 can divide the converted XPS file into a first XPS file including pages 1-3 and a second XPS file including pages 6-7. In this case, pages 4-5, which are not set to be an area to be divided, may be stored as a separate XPS file, or may not be stored according to the user's selection or a preset option.

The XPS file processing unit 142 can analyze a printing option set for the divided XPS file and can reconstruct print tickets of the divided XPS file. More specifically, since a printing option for an XPS file is set in print tickets, the XPS file processing unit 142 can hierarchically analyze the print tickets of the divided XPS file and can reconstruct the print tickets so that a printing option commonly set for a lower level can be set in a print ticket of an upper level.

The control unit 150 can control the components of the printing control apparatus 100. That is, if the control unit 150 receives a command to print a document or a command to divide a document through the UI unit 120, the control unit 150 can control the UI unit 120 to display a UI window to select areas to be divided and a printing option for each area to be divided, and can control the driver unit 140 to divide the selected document into a plurality of XPS files according to the set areas to be divided.

The control unit 150 can control the communication interface unit 110 to transmit the divided XPS files to an image forming apparatus (not illustrated). More specifically, in response to a user command to print the document, the control unit 150 can control the communication interface unit 110 to transmit the plurality of XPS files divided by the driver unit 140 to the image forming apparatus (e.g., the image forming apparatus 160 and/or the image forming unit 195 of the image forming apparatus 190).

The control unit 150 can control the storage unit 130 to store the plurality of XPS files divided by the driver unit 140. The control unit 150 may store each XPS file in the storage unit 130 with a name selected by the user or with a preset name. This operation may be performed according to the user's selection, or may be performed automatically without the user's command to store the XPS file. The control unit 150 may control the storage of the plurality of XPS files divided by the diver unit 140 with the computer 170 and/or the server 180 via the communication interface 110.

As described above, the printing control apparatus 100 according to exemplary embodiments of the present general inventive concept can divide a document selected by the user into a plurality of XPS files, so the use can easily manage a plurality of documents generated by one or more application programs.

FIGS. 2 to 12 illustrate UI windows according to exemplary embodiments of the present general inventive concept.

More specifically, FIG. 2 illustrates an example of UI window to set a printing option for a document. Referring to FIG. 2, if the user selects an “add a document when printing” icon 210 in the UI window 200, the printing control apparatus 100 can combine documents as described above, and if the user selects a “divide a document when printing” icon 220 in the UI window 200, the printing control apparatus 100 can divide a document as described above.

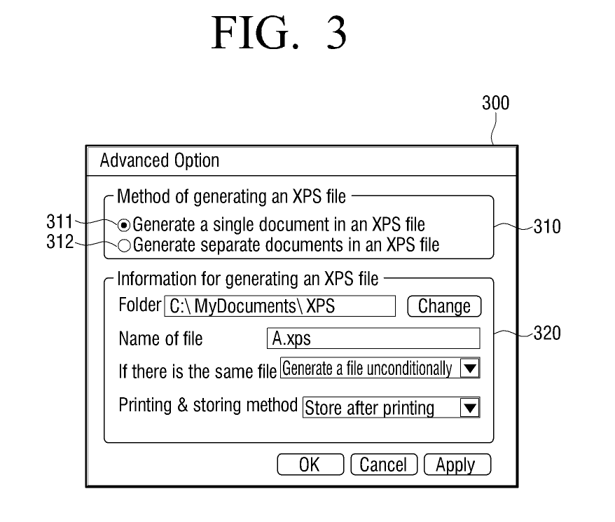

FIG. 3 illustrates an example of UI window which can be displayed when the user selects the “add a document when printing” icon 210. Referring to FIG. 3, the UI window 300 can include an area 310 to select “a method of generating an XPS file” and an area 320 to select “information for generating an XPS file.”

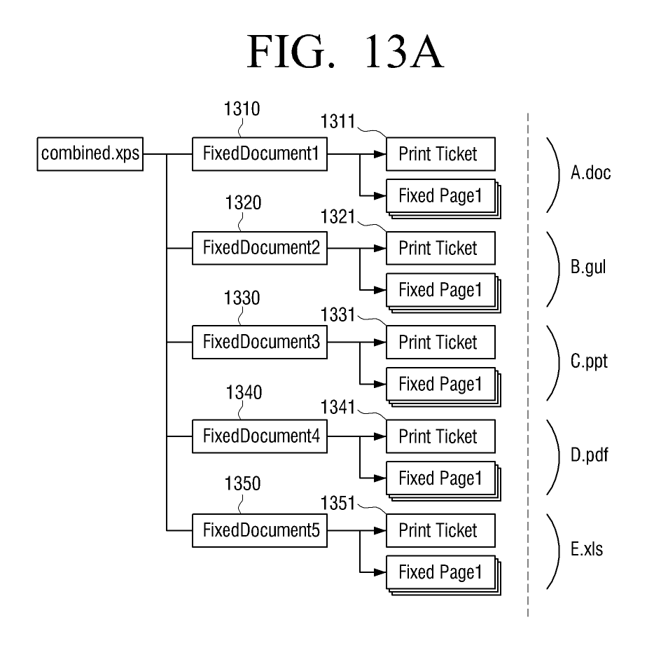

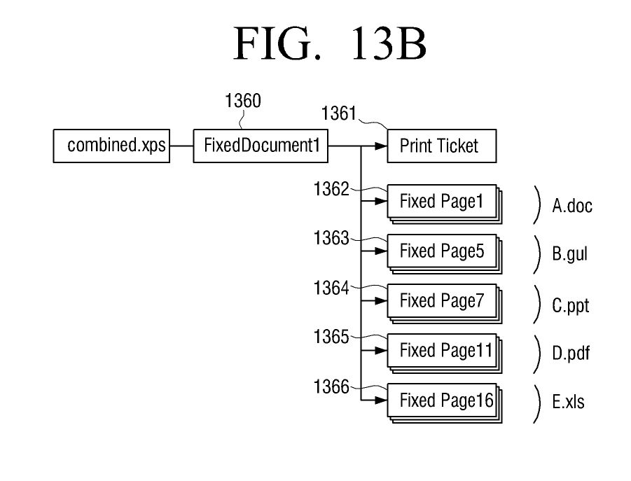

The area 310 to select “a method of generating an XPS file” can be an area to select whether a plurality of documents can be combined to be located in the same document area of an XPS file or are combined to be located in different document areas of the XPS file. More specifically, if the user selects a “generate a single document in an XPS file” icon 311, the generated XPS file can have a logical structure as illustrated in FIG. 13B. If the user selects a “generate separate documents in an XPS file” icon 312, the generated XPS file can have a logical structure as illustrated in FIG. 13A.

The area 320 to select “information for generating an XPS file” can be an area to select a process to be performed when the plurality of documents are combined. More specifically, using the area 320 to select “information for generating an XPS file,” the user can set an area for storing the combined XPS file, a name of the combined XPS file, a method of processing the name when there is the same name, whether to store the combined XPS file, and whether to print the combined XPS file.

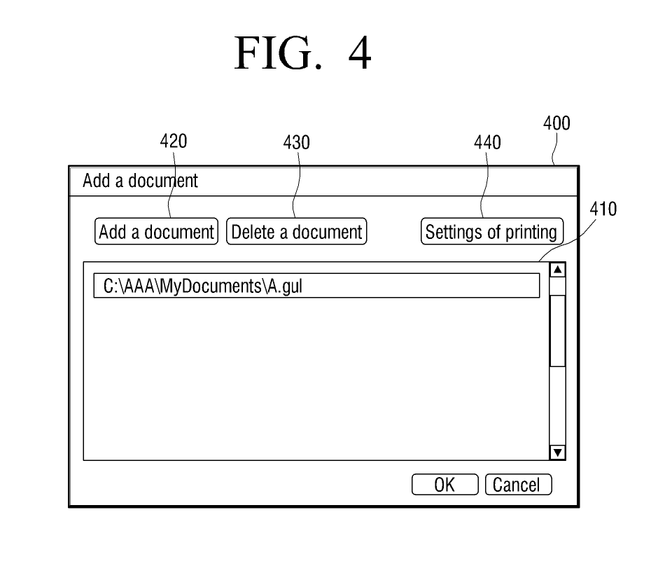

FIG. 4 illustrates a UI window to select a plurality of documents according to exemplary embodiments of the present general inventive concept. Referring to FIG. 4, the UI window 400 can include an area 410 for displaying a selected document, an “add a document” icon 420, a “delete a document” icon 430, and a “settings of printing” icon 440.

The area 410 to display a selected document can be an area to display a document selected to be combined. FIG. 4 illustrates exemplary embodiments of the present general inventive concept in which while setting printing for a single document (A.gul), the user can select the “add a document when printing” icon 210 in FIG. 2, so that the area 410 to display a selected document displays a single document currently.

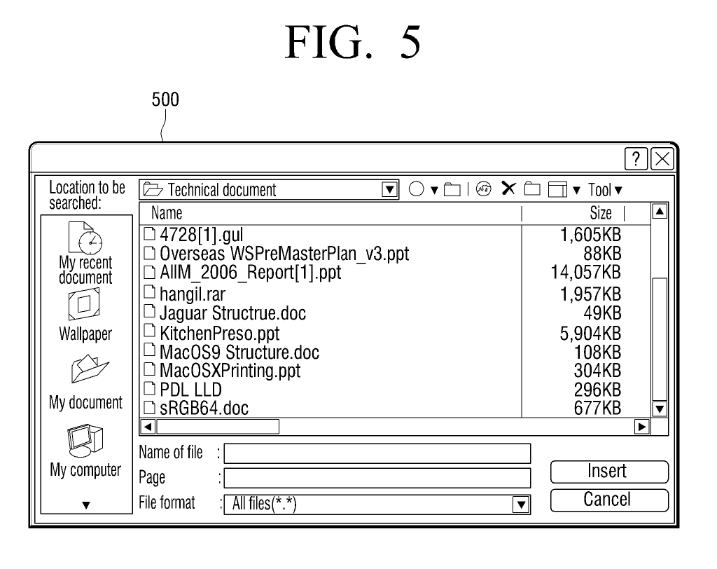

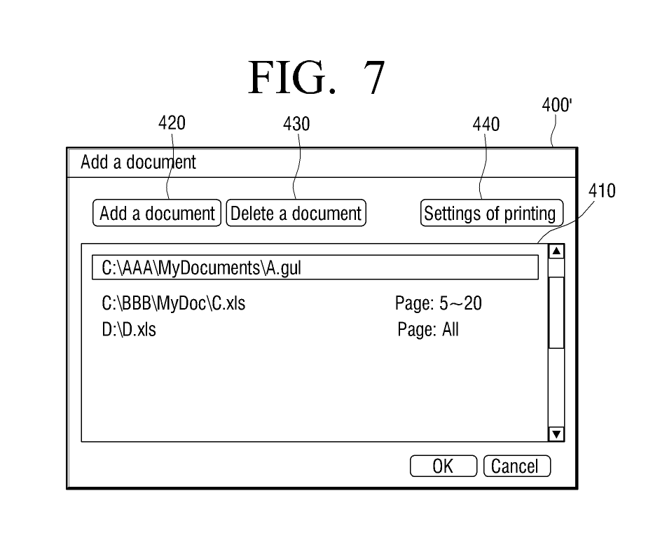

The “add a document” icon 420 can be an icon which is selected when the user wishes to add a document. If the user presses the “add a document” icon 420, a UI window 500 can be displayed as illustrated in FIG. 5. Using the UI window 500, the user can select a document to be added or a portion of a document to be added. If a document is added in this process, the area 410 to display a selected document can display the plurality of selected documents in UI window 400′ as illustrated in FIG. 7.

The “delete a document” icon 430 can be an icon to delete a document when an unnecessary document and/or unwanted document is selected.

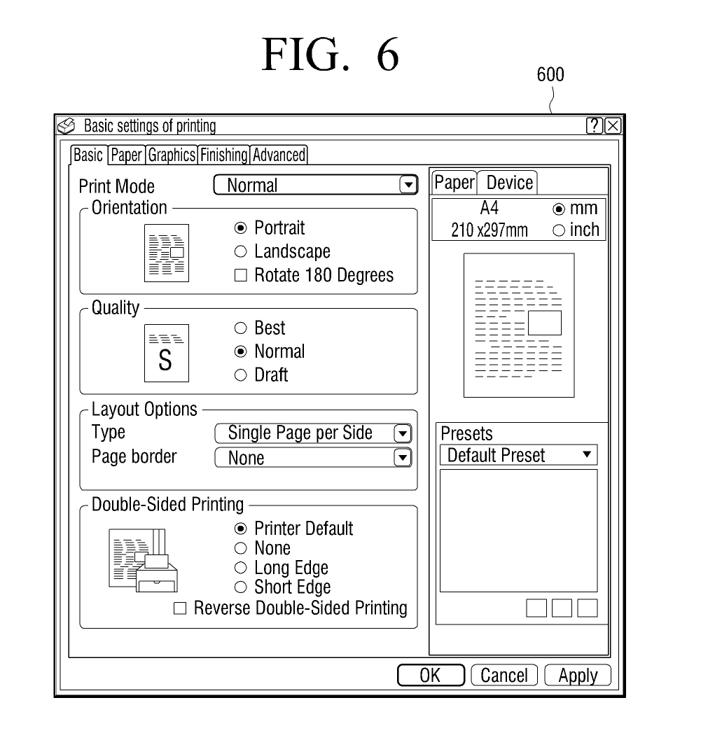

The “settings of printing” icon 440 can be an icon to set a printing option for a selected document. If the user presses the “settings of printing” icon 440, a UI window 600 can be displayed as illustrated in FIG. 6. Using the UI window 600, the user can set a printing option for a selected document. A printing option may be set for each selected document or for the entire selected documents.

In description of FIGS. 3 to 7, the user can select a document to be added after selecting a method of processing documents to be combined. However, the user may select a method of processing documents to be combined after selecting a document to be added.

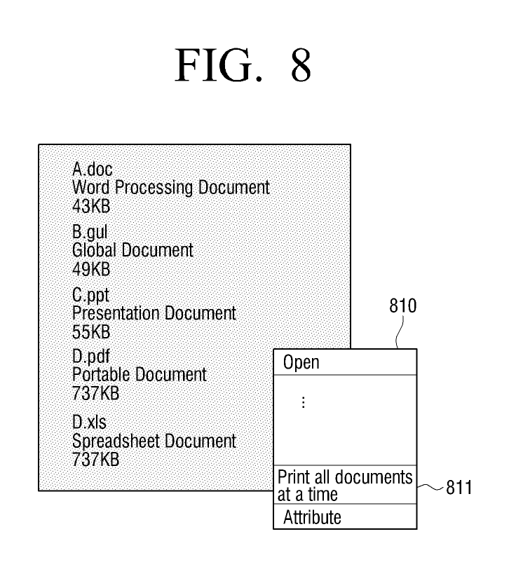

In addition, in description of FIGS. 3 to 7, the user can input a command to print a single document and can select another document. However, the user may also select a plurality of document to be combined at a time as illustrated in FIG. 8.

More specifically, FIG. 8 illustrates an example of UI window which can be displayed when the user selects a plurality of documents at a time. Referring to FIG. 8, the user can select a plurality of documents through a UI window which can display a plurality of documents in a list form, and can select a “print all documents at a time” icon 811 from a menu 810.

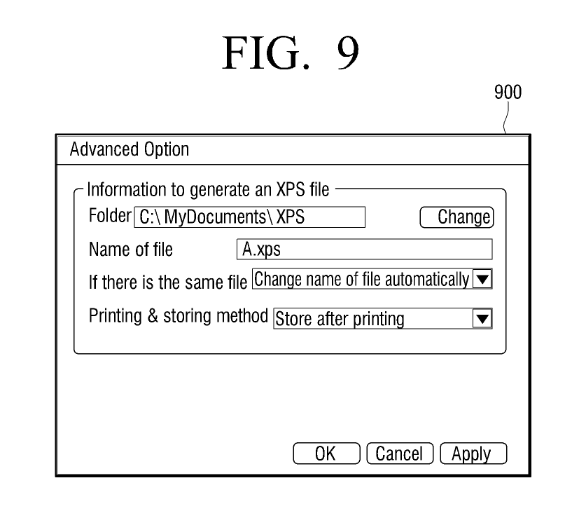

FIG. 9 illustrates a UI window according to exemplary embodiments of the present general inventive concept which can be displayed when the user selects the “divide a document when printing” icon 220 in the UI window 200 of FIG. 2. Referring to FIG. 9, the UI window 900 can include an area to select “information for generating an XPS file.”

The area to select “information for generating an XPS file” can be an area to select a process to be performed after a document is divided. More specifically, using the area to select “information for generating an XPS file,” the user can set an area to store the divided XPS file, a name of the divided XPS file, a method of processing the name when there is the same name, whether to store the divided XPS file, and whether to print the divided XPS file.

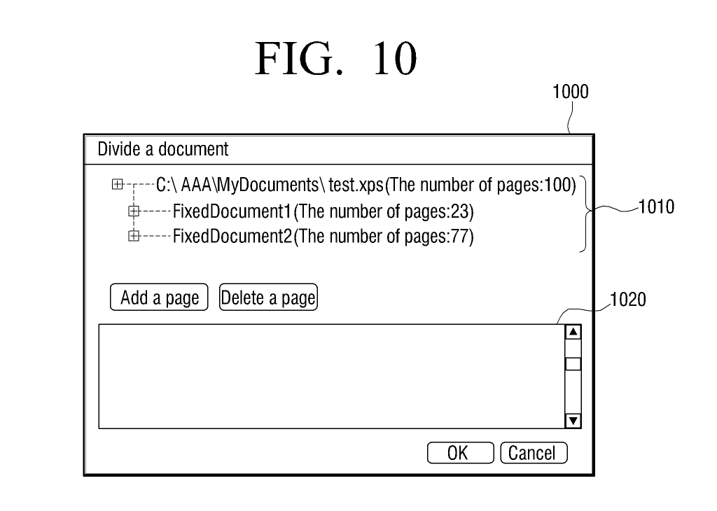

FIG. 10 illustrates an example of UI window to select an area to be divided. Referring to FIG. 10, the UI window 1000 can include an “area to display information regarding a selected document” 1010 and an “area to display an area to be divided which is selected by the user” 1020.

The “area to display information regarding a selected document” 1010 can be an area to display information such as the number of pages of a document which is selected to be divided by the user or documents included in the selected document. In FIG. 10, the “test.xps” file can include two documents, so the two documents and the number of pages of each document can be displayed.

The “area to display an area to be divided which is selected by the user” 1020 can be an area for displaying a currently set area to be divided.

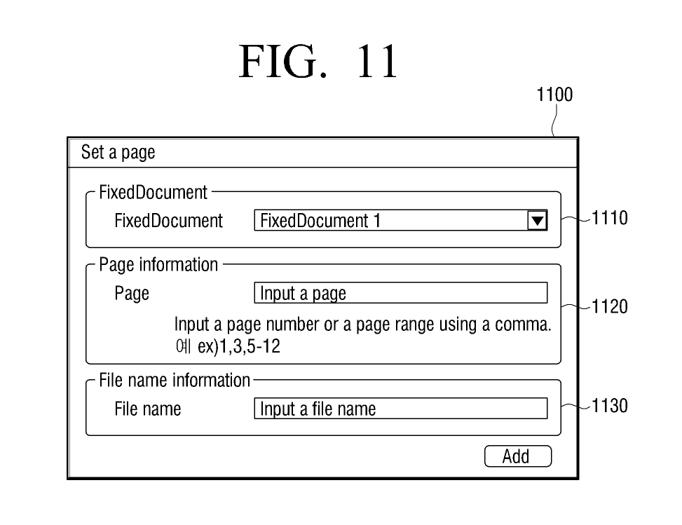

The user can set an area to be divided by pressing an “add a page” icon in the UI window 1000. If the user presses the “add a page” icon, a UI window 1100 is displayed as illustrated in FIG. 11.

FIG. 11 illustrates a UI window according to exemplary embodiments of the present general inventive concept which can be displayed when the user presses the “add a page” icon in the UI window 1000. Referring to FIG. 11, the UI window 1100 includes an “area to select an area to be divided according to a document” 1110, an “area to select an area to be divided according to a page” 1120, and an “area to select a file name of an area to be divided” 1130.

The “area to select an area to be divided according to a document” 1110 can be an area to select an area to be divided according to a document when a currently selected document is an XPS file including a plurality of documents. For example, if a currently selected document includes documents (FixedDocuments) a, b and c, the user may select document a, document b, document c, document a+b, document a+c, or document b+c as an area to be divided.

The “area to select an area to be divided according to a page” 1120 can be an area to select an area to be divided according to a page of a document.

The “area to select a file name of an area to be divided” 1130 can be an area to select a file name of an area to be divided which the user can select using the “area to select an area to be divided according to a document” 1110 or the “area to select an area to be divided according to a page” 1120.

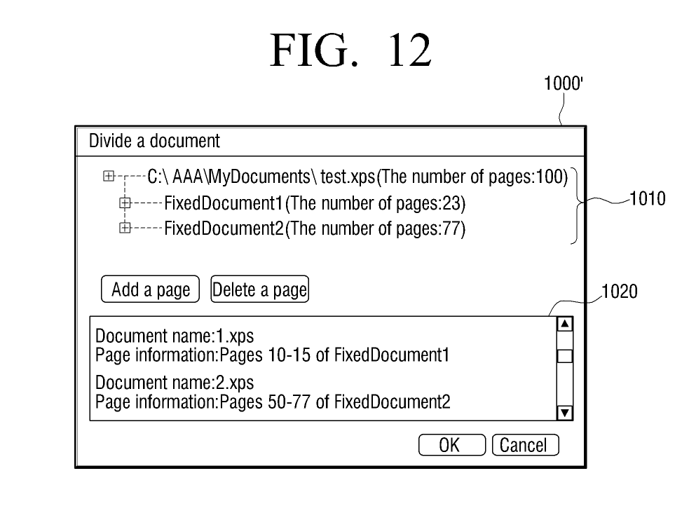

The user can set an area to be divided using the “area to select an area to be divided according to a document” 1110 or the “area to select an area to be divided according to a page” 1120, and can set an additional area to be divided using an “add” icon. If an area to be divided is added, the “area to display an area to be divided which is selected by the user” 1020 in FIG. 10 can display the selected areas to be divided as illustrated in UI window 1000′ in FIG. 12.

In description of FIGS. 9 to 12, the user can select an area to be divided when a method of processing a document to be divided has been selected. However, it is also possible that the user can select a method of processing a document to divided after selecting an area to be divided.

FIGS. 13A and 13B illustrate examples of structure of an XPS file according to exemplary embodiments of the present general inventive concept. More specifically, FIG. 13A illustrates an example of structure of an XPS file that can be generated when the user combines the five documents illustrated in FIG. 8 by selecting the “generate separate documents in an XPS file” icon 312.

Referring to FIG. 13A, the five documents (A.doc, B.gul, C.ppt, D.pdf, and E.xls) can be located in different FixedDocuments 1310-1350 of the combined XPS file. When combining the five documents, if the user sets a printing option for each document, the printing option for each document can be set in a print ticket 1311-1351 corresponding to each document.

FIG. 13B illustrates an example of structure of an XPS file which is generated when the user combines the five documents illustrated in FIG. 8 by selecting the “generate a single document in an XPS file” icon 311. Referring to FIG. 13B, the five documents (A.doc, B.gul, C.ppt, D.pdf, and E.xls) can be located in a single FixedDocument 1360 of the combined XPS file. When combining the five documents, if the user sets a printing option for each document, the printing option for each document can be set in a print ticket 1361 of a corresponding page level.

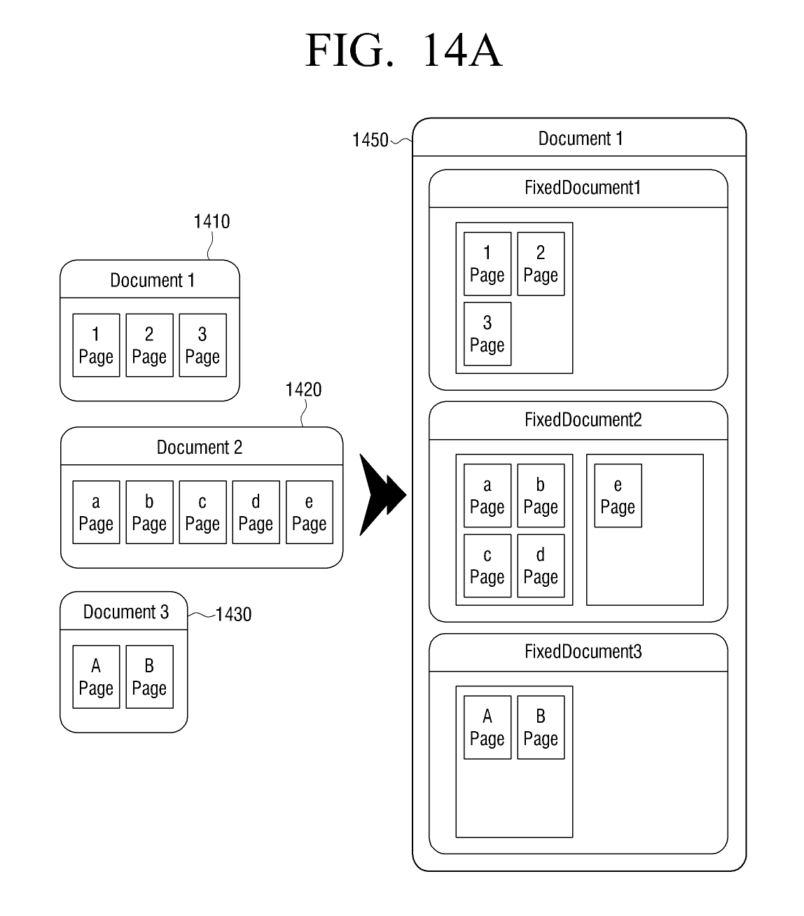

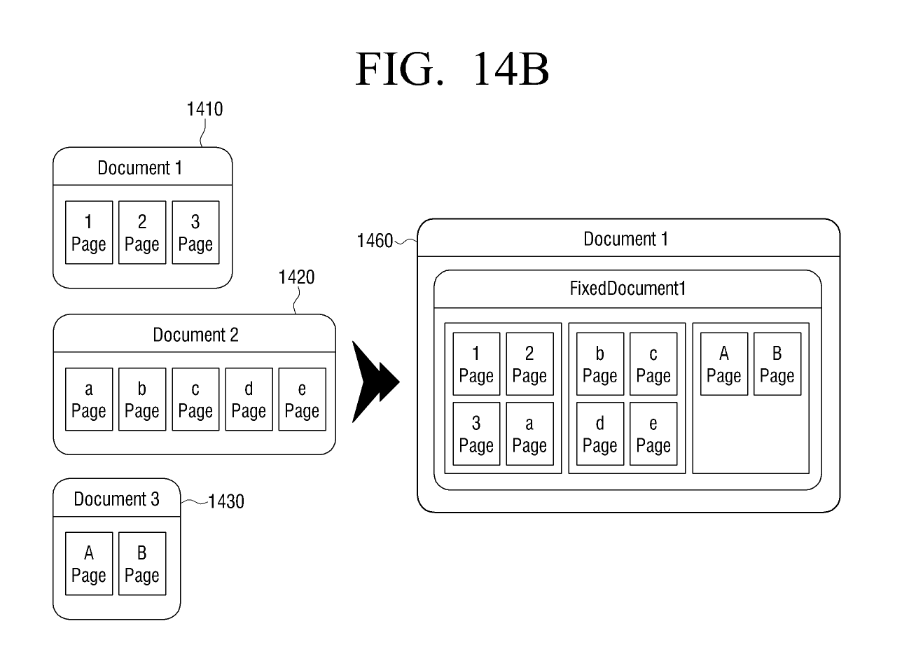

FIGS. 14A and 14B illustrate examples of structure of an XPS file to which printing option “4-up” can be applied. More specifically, FIG. 14A illustrates an example of structure of an combined XPS file in which each document can be located in a different FixedDocument, and FIG. 14B illustrates an example of structure of an combined XPS file in which each document can be located in the same FixedDocument.

Referring to FIG. 14A, three documents 1410, 1420 and 1430 can be located in different FixedDocuments of a combined XPS file 1450. Each FixedDocument can include a 4-up-processed page. More specifically, FixedDocument 1 of the combined XPS file 150 can include a single 4-up-processed page including three pages (pages 1, 2 and 3) of document 1 1410, FixedDocument 2 of the combined XPS file 150 can include two 4-up-processed pages including five pages (pages a, b, c, d and e) of document 2 1420, and FixedDocument 3 of the combined XPS file 150 can include a single 4-up-processed page including two pages (pages A and B) of document 3 1430.

Referring to FIG. 14B, pages of three documents 1410, 1420 and 1430 can be 4-up-processed and can be located in a single FixedDocument of a combined XPS file 1460. More specifically, the combined XPS file 1460 can include a first page in which three pages (pages 1, 2 and 3) of document 1 1410 and a single page (page a) of document 2 1420 are 4-up-processed, a second page in which four pages (pages b, c, d and e) of document 2 1420 are 4-up-processed, and a third page in which two pages (pages A and B) of document 3 1430 are 4-up-processed in FixedDocument 1.

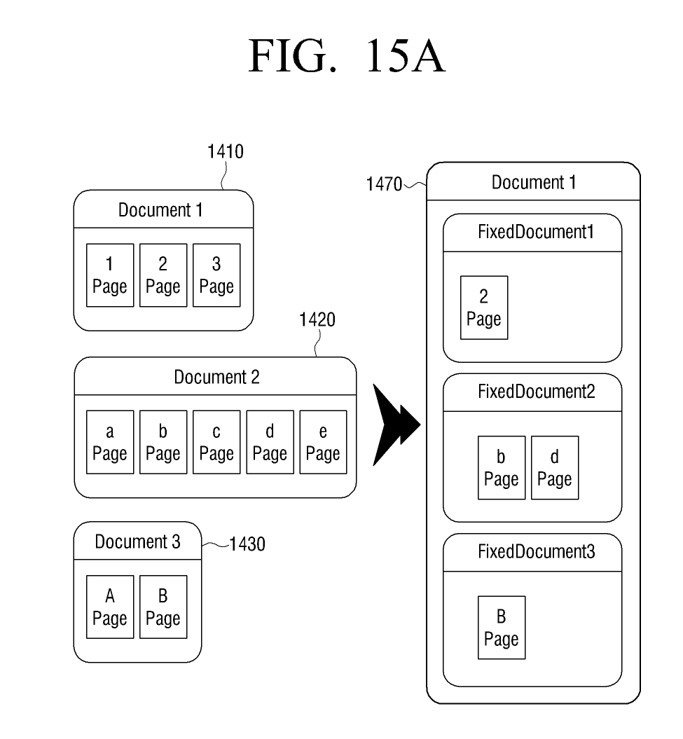

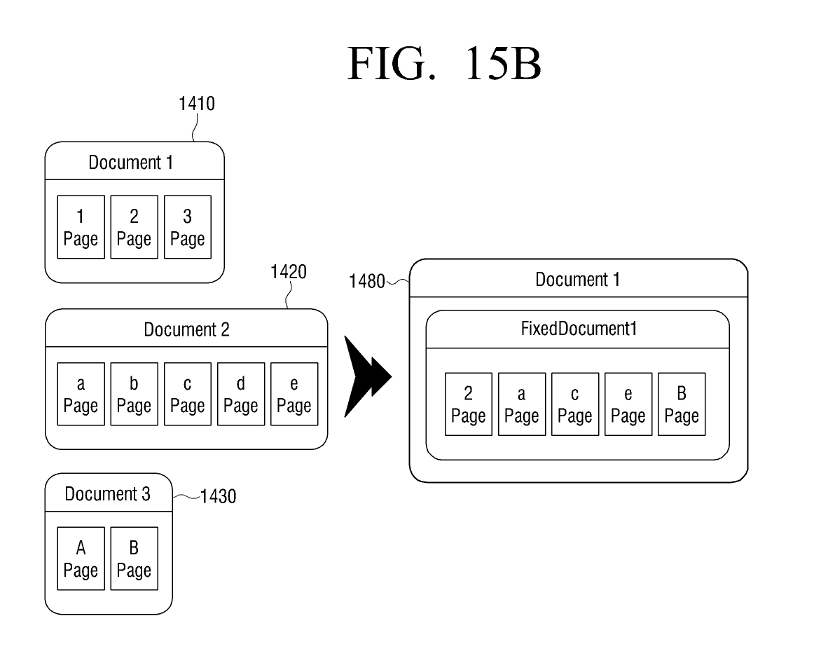

FIGS. 15A and 15B illustrate example structures of an XPS file to which printing option “even-numbered page printing” can be applied. More specifically, FIG. 15A illustrates example structures of a combined XPS file in which each document can be located in a different FixedDocument, and FIG. 15B illustrates example structures of an combined XPS file in which each document can be located in the same FixedDocument.

Referring to FIG. 15A, even-numbered pages of each of the three documents 1410, 1420 and 1430 can be located in a different FixedDocument of a combined XPS file 1470. More specifically, the combined XPS file 1470 can include three FixedDocuments 1, 2, and 3. FixedDocument 1 can include a single page (page 2) of document 1 1410, FixedDocument 2 can include two pages (pages b and d) of document 2 1420, and FixedDocument 3 can include a single page (page B) of document 3 1430.

Referring to FIG. 15B, one or more pages of the three documents 1410, 1420 and 1430 can be located in a single FixedDocument of a combined XPS file 1480. More specifically, the combined XPS file 1480 can include a single FixedDocument 1. FixedDocument 1 can include a single page (page 2) of document 1 1410, three pages (pages a, c and e) of document 2 1420, and a single page (page B) of document 3 1430.

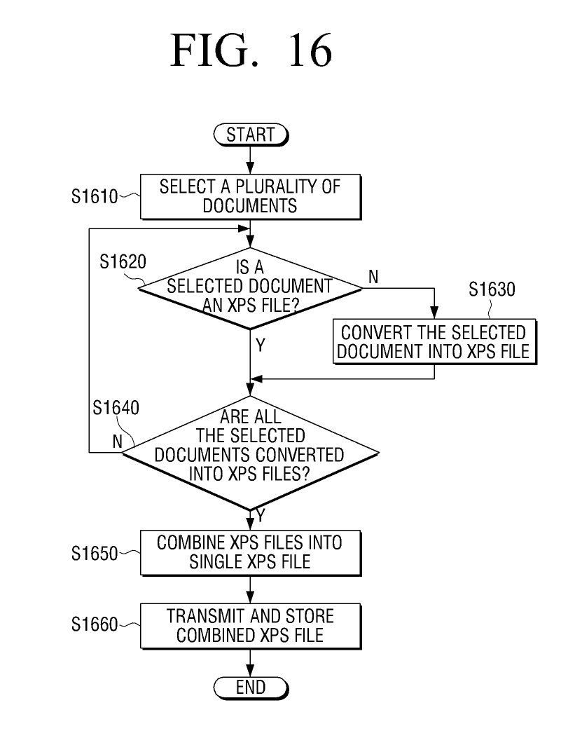

FIG. 16 is a flow chart illustrating a printing control method according to exemplary embodiments of the present general inventive concept.

In operation S1610, a plurality of documents can be selected. More specifically, if a plurality of documents generated using one or more application programs are displayed, the user can select one or more documents. When a command to print a single document is received, another document to be combined with the document can be selected.

A printing option may be set for the selected documents. More specifically, a printing option may be set differently for each document, or may be set identically for the entire documents, or may be set differently for selected documents, or may be set the same for selected documents.

In operation S1640, it can be determined whether or not each selected document is an XPS file. More specifically, if a document selected by the user is an XPS file, the document may not need to be converted into an XPS file. Accordingly, whether or not a selected document is an XPS file can be determined before the selected document is converted into an XPS file. Whether or not a selected document is an XPS file can be determined by, for example, checking an initial binary of the selected document.

In operation S1630, each selected document can be converted into an XPS file. More specifically, if the selected document is not an XPS file, the selected document can be converted into an XPS file.

When converting the selected document into an XPS file, the set printing options can be implemented on corresponding print tickets. More specifically, if a printing option is set for each document, the selected document can be converted into an XPS file by implementing the printing option on a corresponding print ticket of the XPS file.

When converting the selected document into an XPS file, the set printing option can be applied to the XPS file. The operation of generating an XPS file by applying the set printing option to the XPS file was described above with reference to FIGS. 14 and 15, so detailed description is not repeated.

In operation S1640, if all the selected documents are converted into XPS files, the XPS files can be combined into a single XPS file in operation S1650. More specifically, the converted XPS files may be combined to be located in different FixedDocuments of the combined XPS file, or may be combined to be located in the same FixedDocument of the combined XPS file.

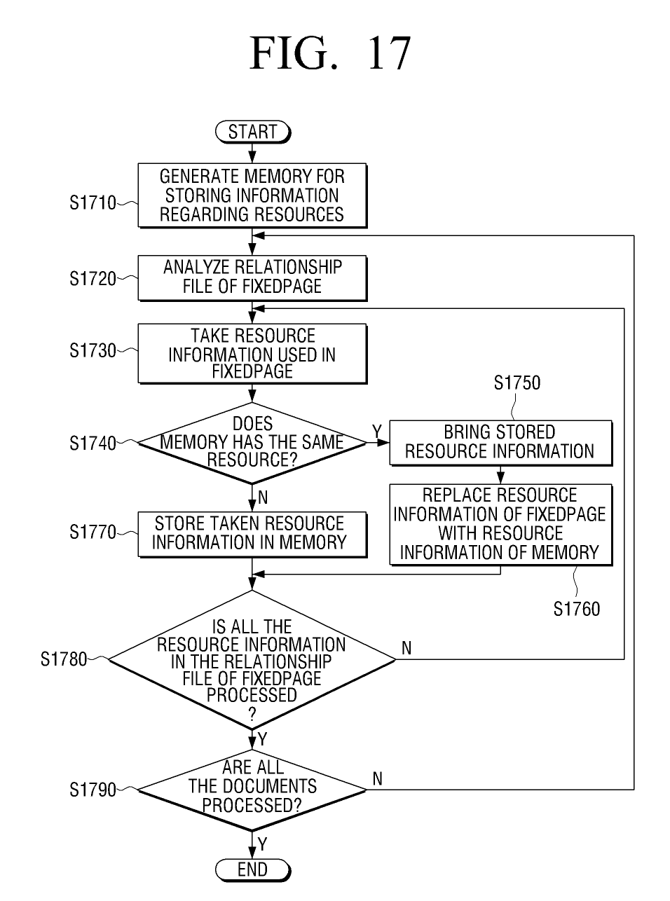

An overlapping resource may be removed by analyzing a relationship file in the combined XPS file. More specifically, documents made by one or more application programs may have a common font and a common image such as a company logo and confidentiality warning. Accordingly, if a relationship file in the combined XPS file is analyzed, an overlapping font resource or an overlapping image resource can be removed. Detailed operation of removing the overlapping resource is described below with reference to FIG. 17.

In operation S1660, the combined XPS file can be transmitted to an image forming apparatus or can be stored. More specifically, if the operations described above have been performed according to the user's printing command, the combined XPS file can be transmitted to an image forming apparatus so that the image forming apparatus can perform a printing job. In addition, the combined XPS file may be stored according to the user's selection or a preset option. The combined XPS file may be stored with a name selected by the user or with a preset name.

In this printing control method according to the exemplary embodiments of the present general inventive concept, documents made by diverse application programs can be combined into a single XPS file, so the user can easily manage a plurality of documents. When combining a plurality of documents into a single document, overlapping resources can be removed, so performance of an image forming apparatus to process the XPS file can be increased and the capacity for storing the XPS file can be reduced. The printing control method illustrated in FIG. 16 can be used by printing control apparatuses having the configuration as illustrated in FIG. 1A and can also be used by printing control apparatuses having different configurations according to the exemplary embodiments of the present general inventive concepts as disclosed herein.

FIG. 17 is a flow chart illustrating a method of removing an overlapping resource according to exemplary embodiments of the present general inventive concept.

In operation S1710, memory to store information regarding resources can be generated. In operation S1720, a relationship file of a FixedPage can be analyzed. In operation S1730, resource information used in the FixedPage can be taken.

In operation S1740, it can be determined whether or not the memory has the same resource. If the memory has the same resource, the stored resource information can be brought from the memory in operation S1750, and in operation S1760, the resource information of the FixedPage can be replaced with the resource information of the memory. If the memory does not have the same resource, the memory can store the taken resource information in operation S1770.

In operation S1780, at least a portion of and/or all the resource information in the relationship file of the FixedPage can be processed in the same manner, and in operation S1790, these operations can be repeated for resource information in a relationship file of a next FixedPage. Overlapping resources in a combined XPS file can be detected and removed.

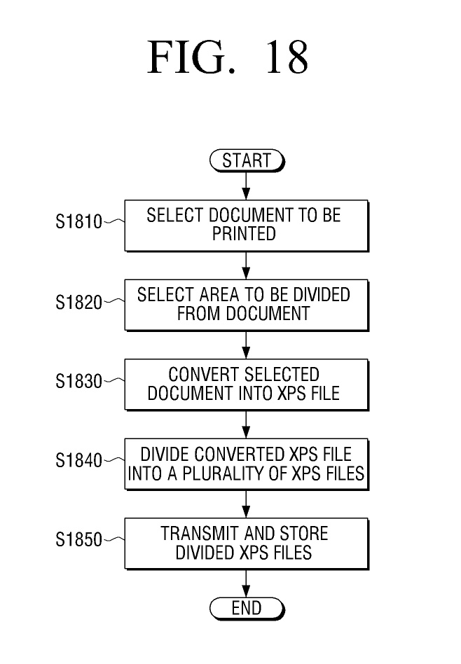

FIG. 18 is a flow chart illustrating a printing control method according to exemplary embodiments of the present general inventive concept.

If a document to be printed is selected in operation S1810, an area to be divided in the document can be selected in operation S1820. More specifically, a document to be printed and/or a document to be divided can be selected through a UI window, and an area to be divided in the selected document can be set according to a page and/or according to a FixedDocument.

A printing option may be set for the selected document. More specifically, a printing option may be set differently for one or more areas (e.g., each area) to be divided or may be set identically for the entire document.

In operation S1830, the selected document can be converted into an XPS file. More specifically, when converting the selected document into an XPS file, the set printing options can be reflected on corresponding print tickets. It may be previously determined whether or not the selected document is an XPS file, and the set printing option may be applied to the XPS file. These operations were described above with reference to FIGS. 1, 14 and 15, so detailed description is not repeated.

In operation S1840, the converted XPS file can be divided into a plurality of XPS files according to the set area to be divided. More specifically, the converted XPS file can be divided into a plurality of XPS files by dividing a resource and a printing option which can be shared by the area to be divided. In the implementation, print tickets of the divided XPS files may be reconstructed by analyzing printing options set for the divided XPS files.

In operation S1850, the divided XPS files can be transmitted to an image forming apparatus or can be stored. More specifically, if the operations described above have been performed according to the user's printing command, the divided XPS files can be transmitted to an image forming apparatus so that the image forming apparatus can perform a printing job. In addition, the divided XPS files may be stored according to the user's selection or a preset option. In this case, the divided XPS files may be stored with names selected by the user or with preset names.

In this printing control method according to the exemplary embodiments of the present general inventive concept, a document selected by the user can be divided into a plurality of XPS files, so the user can easily manage documents made by diverse application programs. The printing control method illustrated in FIG. 18 can be used by printing control apparatuses having the configuration as illustrated in FIG. 1A and can also be used by printing control apparatuses having different configurations.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A printing control apparatus which is connected to an image forming apparatus, the printing control apparatus comprising:
a storage unit to store a plurality of documents;
a user interface (UI) unit to receive a selection of a plurality of documents from among the plurality of documents stored in the storage unit;
an XPS file conversion unit to convert each selected document into an XML (extensible markup language) paper specification (XPS) file;
an XPS file processing unit to combine the converted XPS files into a single XPS file; and
a communication interface unit to transmit the combined XPS file to the image forming apparatus.

2. The printing control apparatus according to claim 1, wherein the storage unit stores the combined XPS file.

3. The printing control apparatus according to claim 1, wherein the UI unit receives a command to print a single document and receives a selection of another document to be combined with the single document.

4. The printing control apparatus according to claim 1, wherein the UI unit receives settings of a printing option for each selected document, and the XPS file conversion unit converts each selected document into an XPS file according to the received settings of the printing option for each of the selected documents on a corresponding print ticket.

5. The printing control apparatus according to claim 1, wherein the XPS file conversion unit renders the selected document by applying the set printing option to the selected document, and converts the rendered document into an XPS file.

6. The printing control apparatus according to claim 1, wherein the XPS file conversion unit determines whether the selected document is an XPS file, and when the selected document is not an XPS file, the XPS file conversion unit converts the selected document into an XPS file.

7. The printing control apparatus according to claim 1, wherein the XPS file processing unit combines the converted XPS files into the single XPS file so that the converted XPS files are located in different FixedDocuments of the combined XPS file.

8. The printing control apparatus according to claim 1, wherein the XPS file processing unit combines the converted XPS files into the single XPS file so that the converted XPS files are located in the same Fixed Document of the combined XPS file.

9. The printing control apparatus according to claim 1, wherein the XPS file processing unit removes an overlapping resource by analyzing a relationship file in the combined XPS file.

10. The printing control apparatus according to claim 9, wherein the overlapping resource is at least one of a font resource and an image resource.

11. The printing control apparatus according to claim 1, wherein the XPS file processing unit reconstructs a print ticket in the combined XPS file by analyzing a printing option set for the combined XPS file.

12. A printing control method of a printing control apparatus which is connected to an image forming apparatus, the method comprising:
selecting a plurality of documents;
converting each selected document into an XML (extensible markup language) paper specification (XPS) file;
combining the converted XPS files into a single XPS file; and
transmitting the combined XPS file to the image forming apparatus.

13. The method according to claim 12, further comprising:
storing the combined XPS file.

14. The method according to claim 12, wherein in the selecting the plurality of documents comprises:
receiving a selection of another document to be combined with the single document when a command to print a document is received.

15. The method according to claim 12, further comprising:
receiving settings of a printing option for each selected document,
wherein the converting each selected document into the XPS file includes converting each selected document for a print ticket according to the set printing option.

16. The method according to claim 15, wherein in the converting each selected document into the XPS file comprises:
rendering the selected document by applying the set printing option to the selected document; and
converting the rendered document into the XPS file.

17. The method according to claim 12, wherein the combining the converted XPS files into the single XPS file comprises:
determining whether the selected document is an XPS file; and
when the selected document is not an XPS file, converting the selected document into the XPS file.

18. The method according to claim 12, wherein the combining the converted XPS files into the single XPS file comprises:
converting the converted XPS files into the single XPS file so that the converted XPS files are located in different Fixed Documents of the combined XPS file.

19. The method according to claim 12, wherein the combining the converted XPS files into the single XPS file comprises:
converting the converted XPS files into the single XPS file so that the converted XPS files are located in the same FixedDocument of the combined XPS file.

20. The method according to claim 12, wherein the combining the converted XPS files into the single XPS file comprises:
removing an overlapping resource by analyzing a relationship file in the combined XPS file.

21. The method according to claim 20, wherein the overlapping resource is at least one of a font resource and an image resource.

22. The method according to claim 12, wherein the combining the converted XPS files into the single XPS file comprise:
reconstructing a print ticket in the combined XPS file by analyzing a printing option set for the combined XPS file.

23. A printing control apparatus which is connected to an image forming apparatus, the printing control apparatus comprising:
a user interface (UI) unit to receive a selection of a document to be printed and receive a selection of an area to be divided from the selected document;
an XPS file conversion unit to convert the selected document into an XML (extensible markup language) paper specification (XPS) file;
an XPS file processing unit to divide the converted XPS file into a plurality of XPS files according to the set area to be divided; and
a communication interface unit to transmit the divided XPS files to the image forming apparatus.

24. The printing control apparatus according to claim 23, further comprising:
a storage unit to store the divided XPS files.

25. The printing control apparatus according to claim 23, wherein the UI unit receives a selection of the area to be divided after the selected document is converted into the XPS file, and receives a selection of the area to be divided according to a FixedDocument of the converted XPS file.

26. The printing control apparatus according to claim 23, wherein the UI unit receives a selection of a printing option for each area to be divided, and the XPS file conversion unit converts each area to be divided according to the set printing option on a print ticket when converting the selected document into the XPS file.

27. The printing control apparatus according to claim 26, wherein the XPS file processing unit divides the converted XPS file into the plurality of XPS files by dividing a resource and a printing option which are shared by the areas to be divided.

28. A printing control method of a printing control apparatus which is connected to an image forming apparatus, the method comprising:
selecting a document to be printed;
selecting an area to be divided from the selected document;
converting the selected document into an XML (extensible markup language) paper specification (XPS) file;
dividing the converted XPS file into a plurality of XPS files according to the set area to be divided; and
transmitting the divided XPS files to the image forming apparatus.

29. The method according to claim 28, further comprising:
storing the divided XPS files.

30. The method according to claim 28, wherein the selecting the area to be divided from the selected document comprises:
selecting the area to be divided according to a Fixed Document of the converted XPS file when the selected document is converted into the XPS file.

31. The method according to claim 28, further comprising:
selecting a printing option for each area to be divided; and
wherein the converting the selected document into the XPS file comprises converting the selected document into the XPS file according to the set printing option on a print ticket corresponding to each area to be divided.

32. The method according to claim 31, wherein the dividing the converted XPS file into the plurality of XPS files according to the set area to be divided comprises:
dividing the converted XPS file into the plurality of XPS files by dividing a resource and a printing option which are shared by the areas to be divided.
